(19) United States
(12) Patent Application Publication
(10) Pub. No.: US 2009/0073510 A1
(43) Pub. Date: Mar. 19, 2009

(54) Passive Transparent Media Adapter

(76) Inventor: Kurt Eugene Spears, La Jolla, CA (US)

Correspondence Address: HDLS Patent & Trademark Services, P.O. BOX 220746, CHANTILLY, VA, 20153-0746, US

(21) Appl. No.: 12/272,894

(22) Filed: Nov. 18, 2008

Related U.S. Application Data
(63) Continuation-in-part of application No. 11/354,840, filed on Feb. 16, 2006.

(51) Int. Cl. H04N 1/04

(52) U.S. Cl. 358/487

(57) ABSTRACT

A passive transparent media adapter magnetically coupling to a scan system is disclosed. The transparent media adapter captures light from a concentrated light source in the scan module and transfers the light to backlight transparent media so that it can be imaged by the scanner module. The transparent media adapter has no active electronics or illumination so does not require control or power to operate. The magnetic coupling allows a significant amount of the concentrated light to be focused into a narrow backlight region that moves in sync with the scan module.

### RELATED APPLICATIONS

This application is a continuation-in-part of U.S. patent application Ser. No. 11/354,840, filed on Feb. 16, 2006.

### BACKGROUND OF THE INVENTION

1. Field of the Invention

The present invention relates to optical scanning system. More specifically, the present invention discloses an adapter for effectively scanning transparent media by an image scanner which requires no active electronic components in the adapter.

2. Description of the Prior Art

A conventional image scanner is capable of producing digital images from printed text or photographic images. In the tradition system, an opaque media is place on the platen glass of the scanner. A light source in the scanner emits light onto the opaque media in order to illuminate the media. Light is reflected off the media and is picked up by a series of lenses or a lens array. The lens array focuses the reflected light onto a sensor array which captures the light in order to produce the digital image of the opaque media.

While the conventional image scanner is useful when used with opaque media, it is ineffective when used with transparent media. The opaque media is capable of reflecting light whereas the light emitted from the scanner light source will simply pass through the transparent media. As a result, the sensor array is unable to detect a useful amount of light and cannot capture an accurate image of the transparent media.

Therefore until now, it was necessary to utilize a dedicated scanner for transparent media. This type of scanner houses the light source in a cover over the top of the transparent media and emits the light on the back of the media. The lens array mounted in the bottom of the scanner then focuses the light onto the sensor array. The sensor array captures the light in order to capture a digital image of the transparent media. However, this transparent media scanner is relatively expensive since an additional motor and drive system are also required in the cover.

Additionally, alignment and coordination between the bottom system and cover system is complex and prone to misalignment.

Furthermore, it is a waste of resources to require the need for a dedicated transparent media scanner when a conventional image scanner can be adapted to scan transparent media.

Therefore there is need for a transparent media adapter that efficiently flattens and backlights transparent media without requiring active electronic components in the adapter and which can be used with a conventional image scanner.

### SUMMARY OF THE INVENTION

To achieve these and other advantages and in order to overcome the disadvantages of the conventional method in accordance with the purpose of the invention as embodied and broadly described herein, the present invention provides an adapter for an image scanner utilized when scanning transparent media.

The transparent media adapter (TMA) of the present invention comprises an optical assembly that captures illumination from an existing scanner light source or concentrated light source in the scanner and uses it to backlight the transparent media such that an image of the transparent media can be acquired by existing scanner optics. The existing scanner optics captures and focuses the light from the media onto the scanner's linear sensor array.

The present invention efficiently backlights the transparent media so that a scanner module can capture a digital image of the media. An advantage of the present invention is that a conventional reduction optic scanner or a contact image sensor scanner can be used to scan transparent media without the need for a specialized transparent media scanner.

The TMA comprises a mirror module with a plurality of mirror assemblies. In use the TMA is positioned such that illumination from the existing scanner module light source or from a concentrated light source in the scanner module is captured and reflected by the mirror assemblies and direct the light toward the media. Thus the media is backlit and the existing scanner module can use a lens array to create an image of the media on the sensor array.

Additionally, since the TMA does not comprise any active electronic components, no power supply, motor, or drive system are required. As a result, the cost and complexity of the device are significantly reduced.

Furthermore, with the addition of magnets to the mirror module and scanning system of the scanner, the TMA can follow the movement of the scanner as it scans. The magnets of the mirror module and scan system couple the TMA and scan module together. This allows the TMA and the underlying scan module to properly align and move in a synchronized manner. As a result, multiple slides or negatives can be scanned in one scan operation.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating a side view of an optical system of an image scanner and passive transparent media adapter according to an embodiment of the present invention;

FIG. 2 is a drawing illustrating a side view of an optical system of an image scanner and passive transparent media adapter that follows movement of the scanner according to an embodiment of the present invention;

FIG. 3 is a drawing illustration a top view of a transparent media adapter according to an embodiment of the present invention;

FIG. 4A is a drawing illustrating a side view of a transparent media adapter according to an embodiment of the present invention; and

FIG. 4B is a drawing illustrating a top view of a transparent media adapter according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

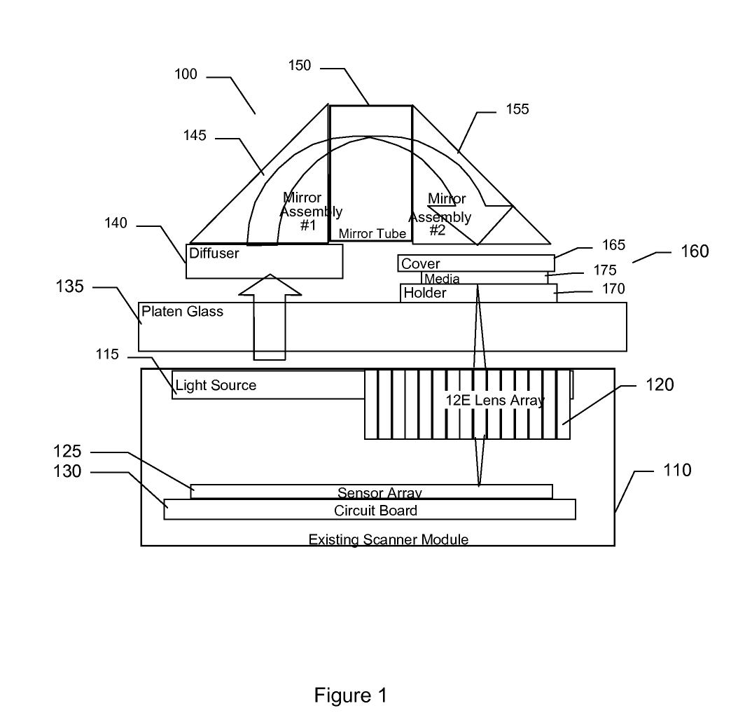

Refer to FIG. 1, which is a drawing illustrating a side view of an optical system of an image scanner and passive transparent media adapter according to an embodiment of the present invention.

As shown in FIG. 1, a scanner module 110 comprises a circuit board 130 with a sensor array 125, a light source 115, and a lens array 120. A platen glass 135 is located above the scanner module 110. In conventional image scanning, for example scanning a page of printed text, the light source 115 emits light to illuminate the printed text. The lens array 120 focuses the light reflected from the page onto the sensor array 125. The sensor array 125 and circuit board 130 capture the digital image of the printed text.

However, in order to capture a digital image of transparent media 175, for example a 35 mm slide, the media 175 must be backlit or illuminated from behind the media 175. In the embodiment shown in FIG. 1, the transparent media adapter of the present invention comprises a media holder 160, a mirror module 100, and a diffuser 140. The media holder 160 flattens and positions the transparent media 175. The diffuser 140 diffuses light emitted by the light source 115 of the scanner module 110. The mirror module 100 reflects the diffused light onto the transparent media 175. In this way, the transparent media adapter of the present invention efficiently backlights the transparent media 175 so that the scanner module 110 can capture a digital image of the media 175.

In this embodiment the mirror module 100 comprises a first mirror assembly 145, a second mirror assembly 155, and a mirror tube 150. The first mirror assembly 145 is basically a coated right angle prism that allows light to enter from below (where the diffuser 140 is located) and allows light to exit into the mirror tube 150 located on the right. Therefore, the first mirror assembly 145 has transparent surfaces on the bottom and right side and the remaining three surfaces of the first mirror assembly 145 are mirrors that reflect light.

The mirror tube 150 is a cube or rectangle with transparent surfaces on the left and right faces. The remaining four faces are mirrors.

The second mirror assembly 155 is similar to the first mirror assembly 145. It has transparent surfaces on the left face and bottom face and is mirrored on the remaining three sides.

In an embodiment of the present invention, the three optical components which make up the mirror module 100 are molded with plastic outside the reflecting surfaces and air inside the assembly. The plastic is coated with a reflecting material to build a low cost mirror assembly.

In an embodiment of the present invention, the media holder 160 comprises a media holder base 170 and a media holder cover 165. The media holder cover 165 located above the transparent media 175 is transparent or a second diffuser. Alternatively, a second diffuser is located above the cover adjacent to the second mirror assembly 155.

In the embodiment illustrated in FIG. 1, the TMA is stationary during the scanning operation, while the scanner light source 115 and lens array 120 move across the transparent media 175.

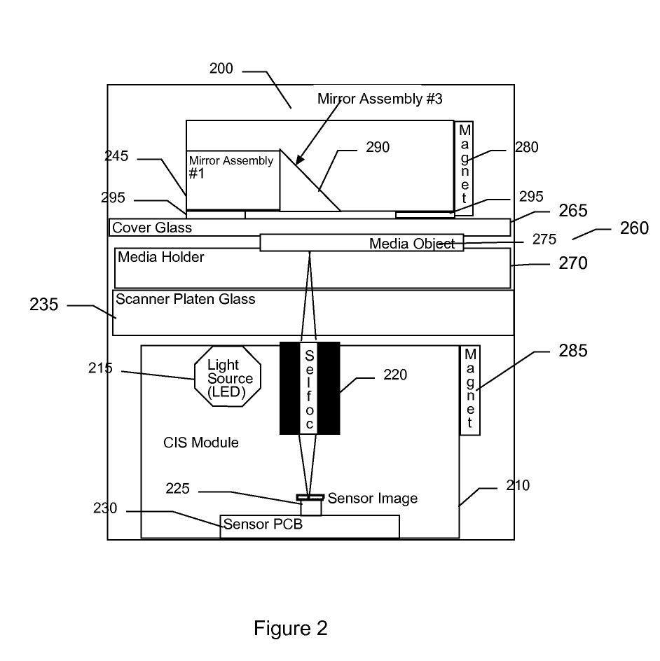

Refer to FIG. 2, which is a drawing illustrating a side view of an optical system of an image scanner and passive transparent media adapter that follows movement of the scanner according to an embodiment of the present invention.

In the embodiment illustrated in FIG. 2, a third mirror assembly 290 is added to allow the first mirror assembly 245, the second mirror assembly, and the mirror tube to be located in a horizontal orientation. This allows the passive transparent media adapter to achieve a very low profile.

Additionally, magnets 280, 285 that are used to couple the existing scan module and the TMA have been added. This allows the TMA and the underlying scan module to properly align and move in a synchronized manner. The magnets 280, 285 keep the TMA aligned with the scan module as it moves from left to right or from right to left. As a result, multiple slides or negatives can be scanned in a single scanning operation.

Since the magnets 280, 285 magnetically couple with each other, the motor and drive system of the existing scan module effectively moves the mirror module 200 of the transparent media adapter. Therefore, there is no need for a separate motor or drive system for the TMA. This greatly reduces the cost and complexity of the TMA.

As shown in FIG. 2, light emitted from the scanner light source 215 is reflected by the third mirror assembly 290 and directed to the first mirror assembly 245. The first mirror assembly 245 reflects this light and directs it to the second mirror assembly via the mirror tube. The second mirror assembly reflects the light toward the third mirror assembly 290. Finally, the third mirror assembly 290 reflects the light onto the transparent media 275 effectively backlighting the media 275. The scanner lens 220 focuses this light onto the scanner sensor 225 which captures the image.

In this embodiment, the first mirror assembly 245, the second mirror assembly, and the mirror tube are located in a horizontal orientation, the overall height of the TMA is reduced making the TMA more compact.

A TMA magnet 280 or a plurality of TMA magnets are attached to the mirror module 200. A scanner magnet 285 or a plurality of scanner magnets is attached to the scan module 210. The TMA magnet 280 couples with the scanner magnet 285. As the scan module 210 moves across the transparent media 275 the magnetically coupled mirror module 200 moves in a synchronized manner in the same direction and backlights the transparent media 275 using light from the scan module 210. This allows images of larger or multiple transparent media objects to be captured.

A plurality of sliders 295 is positioned on the bottom of the mirror module 200 to enhance movement of the mirror module 200. These sliders cooperate with the physical properties of the media holder cover 265 to provide a low friction environment in which the TMA moves across the media holder cover 265. In some embodiments multiple sliders are used. In other embodiments a single slider is used. In yet other embodiments, the bottom of the mirror module is treated, coated, or fabricated from low-friction material to act as a slide.

In the embodiment illustrated in FIG. 2, two magnets, one on the TMA module and one on the scan module are shown. However in other embodiments, more than two magnets are used to provide accurate side to side alignment. For example, multiple magnets located in several locations across the scan line provide more accurate alignment than magnets at a single location.

In another embodiment of the present invention, the TMA module or scan module use a metal plate instead of a magnet, as long as the magnet on the other module is strong enough to provide sufficient coupling to the metal plate. For example, when using a scan module without a magnet installed, positioning a magnet or magnets on the TMA module allows the magnet of the TMA module to couple with the scan module and follow the scan module movement. Alternatively, a metal plate is attached to the mirror module. A magnet on the scan module couples to the metal plate and allows the mirror module to move with the scan module.

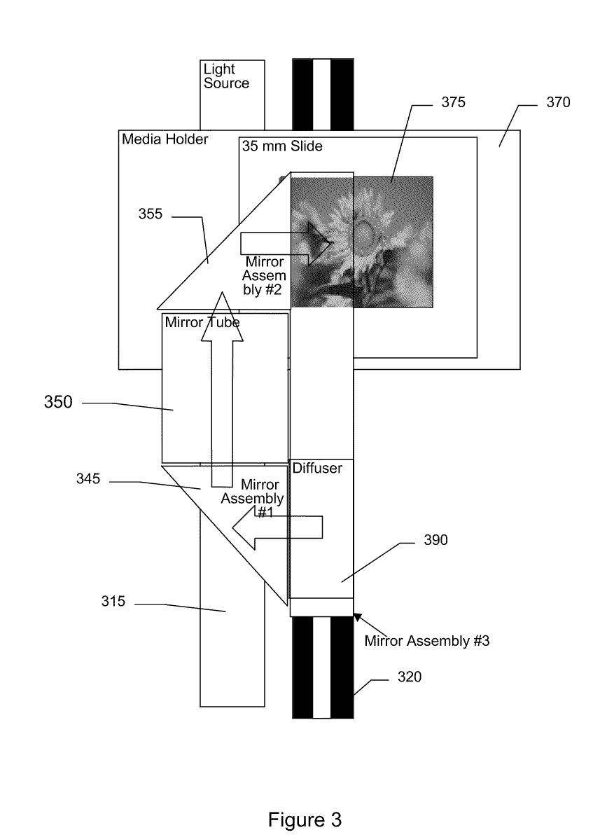

Refer to FIG. 3, which is a drawing illustration a top view of a transparent media adapter according to an embodiment of the present invention.

In FIG. 3, a top view of the TMA is shown with a 35 mm slide as an example. Obviously, the transparent media 375 can be a negative, film, transparency, or other type of transparent media.

This view illustrates the direction of light through the TMA. In use, the transparent media 375 is installed in the media holder 370. Once the scan operation begins, light is emitted from the light source 315 of the scan module. The light shines onto the third mirror assembly 390 and is reflected to the first mirror assembly 345. This light is then reflected into the mirror tube 350 and travels to the second mirror assembly 355. The second mirror assembly 355 reflects the light onto the third mirror assembly which reflects the light onto the transparent media 375. The lens 320 of the scan module cooperates with the sensor of the scan module to capture an image of the transparent media. As a result, light from a light source of a scan module is used to effectively and efficiently backlight transparent media.

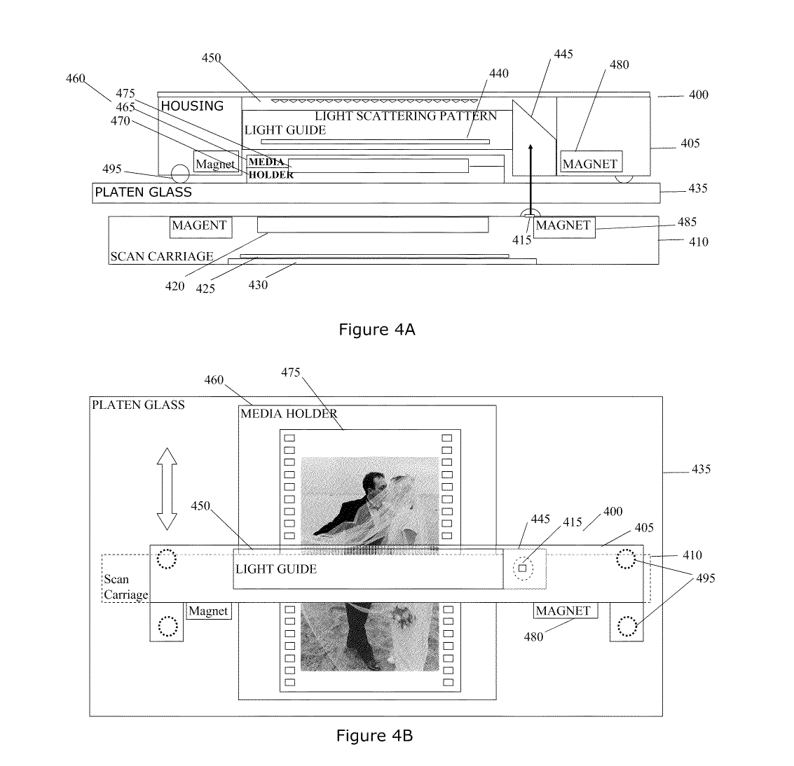

Refer to FIG. 4A, which is a drawing illustrating a side view, and FIG. 4B, which is a drawing illustrating a top view, of an optical system of an image scanner and passive transparent media adapter that follows movement of the scanner according to an embodiment of the present invention.

In the embodiment illustrated in FIG. 4A and FIG. 4B, the light source 415 is a concentrated high intensity source such as a light emitting diode (LED) or LED array. The light source 415 is located on the scanner module 410 and is oriented to direct the light through platen glass 435 to the first mirror assembly 445. The use of the concentrated source allows a reduction in the size of the first mirror assembly 445 and a reduction in the size of the TMA.

In an embodiment the LED or plurality of LEDs in the light source 415 are white LEDs. In another embodiment the LED or plurality of LEDs in the light source 415 are colored LEDs. The colored LEDs comprise colors such as red, green, blue, or a combination of these colors. In an embodiment an infrared LED or ultra-violet (UV) LED is provided to allow additional scanning capabilities.

In the embodiment illustrated in FIG. 4A and FIG. 4B, the light source 415 emits light directed toward the first mirror assembly 445. The first mirror assembly 445 redirects the light in the horizontal direction into the light guide 450. The light guide 450 comprises reflective surfaces on the top surface and two side surfaces but allows light to exit downward through a diffuser 440. In addition, the light guide 450 has a light scattering pattern located on the top surface and optionally other surfaces. The light scattering pattern scatters the light and is patterned to obtain uniform output intensity through the diffuser 440 along the length of the light guide 450. In an embodiment the light guide 450 comprises a molded plastic light guide. In another embodiment the light guide 450 comprises an air space with external surfaces that are covered with reflective white or mirror coatings.

The embodiment illustrated in FIG. 4A and FIG. 4B utilizes a TMA housing 405 to properly align the components of the TMA 400. A TMA magnet 480 or a plurality of TMA magnets are attached to the TMA housing 405 and are located to properly interact with the scanner magnet 485 or plurality of scanner magnets attached to the scanner module 410. The TMA magnet 480 couples with the scanner magnet 485 to enable the TMA module 400 to move in a synchronized manner with the scanner module 410. The arrow in FIG. 4B indicates the direction of motion for the scanner module 410 and the TMA module 400.

In the embodiment illustrated in FIG. 4A and FIG. 4B, a plurality of sliders 495 are located between the TMA housing 405 and the platen glass 435. These sliders 495 cooperate with the physical properties of the platen glass 435 to provide a low friction environment in which the TMA housing 405 can move in synchronization with the scanner module 410. In some embodiments, the mirror module comprises two or three mirror assemblies; first mirror assembly and second mirror assembly or first mirror assembly, second mirror assembly, and third mirror assembly. In the embodiment illustrated in FIG. 2 and FIG. 3, the third mirror assembly is one piece that extends from the first mirror assembly to the second mirror assembly. However, in other embodiments of the present invention the mirror module comprises other configurations. For example, in other embodiments, the third mirror assembly comprises two separate pieces. One piece positioned with the first mirror assembly and another piece with the second mirror assembly. In another embodiment the third mirror assembly is formed together with the first mirror assembly and the second mirror assembly. In another embodiment the first mirror assembly, second mirror assembly, and third mirror assembly are formed in one piece.

Additionally, in some embodiments the mirror tube is formed together with some or all of the mirror assemblies. For example, in some embodiments the entire mirror module is formed in one piece.

In an embodiment of the present invention, the mirror module is manufactured by creating an outer molded assembly and aluminizing the inner surfaces. For example, using the mirror module as a mold insert, the housing is molded around the mirror module. When the mold insert is removed, all the inner surfaces of the part are aluminized to be reflective. As a result, a mirrored cavity in the shape of the mirror module is achieved. Alternatively, the mirror assemblies are built with glass or plastic.

Furthermore, in some embodiments of the present invention, the mirror module comprises optical fibers to transfer light from the light source to backlight the media. This allows the passive transparent media adapter to achieve an extremely low profile. For example, a plurality of optical fibers is installed in a housing. Light emitted from the light source travels through the optical fibers and shines onto the transparent media.

As described above, the present invention provides a compact, low cost transparent media adapter that is magnetically coupled to the scan system. This allows the cost of the transport system to be reduced because the need for a motor and drive system are eliminated.

The present invention captures a large amount of light from the system's existing scan module or from a concentrated light source in the scan module and transfers this light to backlight the transparent media so it can be imaged by the underlying scanner module. The transparent media adapter captures a significant amount of light and transfers it to a narrow region to provide a high intensity backlight solution.

Additionally, the TMA is passive meaning it has no active electronic components. As a result, it is simpler to integrate into existing scan systems because it utilizes the existing illumination and sensor systems and their corresponding control systems. Since the TMA has no active electronics or illumination, it does not require control or power to operate. The magnetic coupling allows a significant amount of the existing system illumination or light from a concentrated light source to be focused into a narrow backlight region that moves in sync with the scan module. This allows multiple frames of negative and slides to be captured in a minimal amount of time.

The passive transparent media adapter of the present invention solves the problem of how to flatten and backlight transparent media for a CIS or reduced optics based scanner. Because it is passive, it reduces the cost and complexity of the TMA solution. The magnetic coupling allows a significant amount of system illumination to be focused into a narrow region that moves in sync with the scan module.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A passive transparent media adapter for a scanner module, comprising:
a media holder for holding transparent media;
a concentrated light source in the scanner module; and
a mirror module comprising a plurality of reflective surfaces for reflecting light emitted by the light source onto the transparent media.

2. The passive transparent media adapter of claim 1, further comprising:
a diffuser connected to the mirror module for diffusing light.

3. The passive transparent media adapter of claim 1, the mirror module comprising:
a first mirror assembly; and
a light guide connected to the first mirror assembly, the first mirror assembly redirecting light from the light source into the light guide.

4. The passive transparent media adapter of claim 1, the mirror module comprising:
a first mirror assembly; and
a light guide connected to the first mirror assembly, the light guide allowing light to exit through a diffuser connected to the mirror module.

5. The passive transparent media adapter of claim 3, the light guide further comprising a light scattering pattern for obtaining uniform output intensity along the length of the light guide.

6. The passive transparent media adapter of claim 1, further comprising at least one adapter magnet connected to the mirror module.

7. The passive transparent media adapter of claim 6, further comprising at least one scanner magnet connected to the scanner module, the at least one adapter magnet magnetically coupling with the at least one scanner magnet.

8. The passive transparent media adapter of claim 7, further comprising:
a plurality of sliders mounted to the mirror module for enhancing sliding of the mirror module.

9. A passive transparent media adapter for a scanner module, comprising:
a media holder for holding transparent media;
a concentrated light source in the scanner module; and
a mirror module for transferring light emitted from the concentrated light source onto the transparent media.

10. The passive transparent media adapter of claim 9, further comprising:
a diffuser connected to the mirror module for diffusing light emitted from the concentrated light source.

11. The passive transparent media adapter of claim 9, the mirror module comprising:
a first mirror assembly for redirecting light emitted from the concentrated light source; and
a light guide bar connected to the first mirror assembly, the light guide bar comprising a light scattering pattern for obtaining uniform output intensity along the length of the light guide.

12. The passive transparent media adapter of claim 9, the mirror module comprising:
a first mirror assembly; and
a light guide bar connected to the first mirror assembly, the first mirror assembly redirecting light emitted from the concentrated light source into the light guide.

13. The passive transparent media adapter of claim 12, the light guide allowing light to exit through a diffuser connected to the mirror module.

14. The passive transparent media adapter of claim 9, the concentrated light source comprising a light emitting diode or a plurality of light emitting diodes.

15. The passive transparent media adapter of claim 9, the concentrated light source comprising at least one white or colored light emitting diode.

16. The passive transparent media adapter of claim 9, further comprising at least one adapter magnet connected to the mirror module.

17. The passive transparent media adapter of claim 16, further comprising at least one scanner magnet connected to the scanner module.

18. The passive transparent media adapter of claim 17, where at least one adapter magnet magnetically couples with at least one scanner magnet to allow the mirror module to follow movement of the scanner magnet.

19. The passive transparent media adapter of claim 18, further comprising:
a plurality of sliders mounted to the mirror module for enhancing movement of the mirror module.

20. A passive transparent media adapter for a scanner module, comprising:
a media holder for holding transparent media;
at least one light emitting diode in the scanner module for emitting concentrated light;
a first mirror assembly for redirecting the concentrated light; and
a light guide bar with light scattering pattern connected to the first mirror assembly, the light scattering pattern patterned to obtain uniform output intensity along the length of the light guide bar.
